(19) United States
(12) Patent Application Publication
(10) Pub. No.: US 2007/0172408 A1
(43) Pub. Date: Jul. 26, 2007

(54) Amorphous carbon particles and composite material used thereof

(76) Inventor: Yoichi Takagi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/588,958

(22) PCT Filed: Oct. 13, 2004
(86) PCT No.: PCT/JP04/15073

§ 371 Date: Aug. 10, 2006

(30) Foreign Application Priority Data
Feb. 12, 2004 (JP) 2004-035668

(51) Int. Cl. C01B 31/00; C09C 1/44; C04B 24/00; C01B 31/02; C04B 14/00

(52) U.S. Cl. 423/445 R; 106/472; 106/717; 106/814

(57) ABSTRACT

The disclosed are amorphous carbon particles extracted from combustion ash of petroleum coke, each of which provides a non-circular section, and which have a weight depreciation rate after 60 minutes' standing at a maintaining temperature of 500° C. in the presence of air being in the range of less than 30%, and also have a mean average particle size of 50-1 μm; and composite material in which the amorphous carbon particles are blended in a matrix of organic material or inorganic material. Thus, it becomes feasible to obtain economically amorphous carbon particles which excel in rigidity, strength and have particularly small specific surface area and pore volume, and to provide a composite material of which characteristics are improved by blending the amorphous carbon.

### TECHNICAL FIELD

The present invention relates to amorphous carbon particles and composite materials used thereof. More particularly, the present invention relates to amorphous carbon particles which excel in various characteristics such as material strength, corrosion resistance, electro conductivity, thermal resistance, size stability, etc., as well as economical efficiency, and composite materials used thereof.

### BACKGROUND ARTS

Amorphous carbon is a unique carbon material which provides with homogeneous vitreous texture, and which is expected to apply to various fields because of their excellent characteristics such as mechanical strength, alkaline resistance, acid resistance, electro conductivity, etc., in recent years. As a method of manufacturing such an amorphous carbon, a method of burning and carbonizing a molded article of thermosetting resin such as a phenolic resin or a furfuryl alcohol resin is known as described in the Patent Literatures 1-3. However, the amorphous carbon which is produced by the method of burning and carbonizing the thermosetting resin becomes costly, and it tends to be insufficient residual carbon content and thus it is has a lesser material strength than the intended value.

Incidentally, petroleum coke is a low-cost carbonaceous fuel of which calorific value is higher than coal, and it is being used widely as a fuel such as that for industrial boilers now. In the combustion ash come out of a combustion furnace where such a petroleum coke was used, unburned carbonaceous constituent is contained at a ratio of not less than 70%, and with respect to the dry calorific value it is equal to coke. Thus, it is used again as fuel for the cement kiln, or used as a carbonaceous reductant for melting furnace of refinery. However, since the activity or reactivity of the unburned carbonaceous constituent is extremely low and the combustion ash includes a large volume of impurities other than carbon content, the evaluation of the combustion ash as fuel or carbonaceous material is low. Thus, there is a high possibility that the combustion ash will be handled as an industrial waste for reclamation in near future.

Although various technologies has been advocated for utilizing effectively unburned carbonaceous constituent in combustion ash, much of such technologies would not be applicable for the unburned carbonaceous constituent in the combustion ash of the petroleum coke. For instance, the technology described in the Patent Literature 4 is that dust coal boiler ash is mixed with an organic solvent of which specific gravity is smaller than one and which is not miscible with water, then the resultant mixture is added to water in order to float up the carbonaceous constituent along with the organic solvent, and the obtained floating substance accompanying the carbonaceous constituent is used as fuel. However, the unburned carbonaceous constituent in the combustion ash of the petroleum coke is separated from the organic solvent so as to precipitate to bottom and not to float up.

Moreover, in the Patent Literature 5, a technology for manufacturing fly ash with low carbon content and high vitrification rate is disclosed, wherein fly ash which includes carbon and which is accompanied with oxidizing agent is injected from a nozzle into combustion gas which is formulated by injecting fuel and oxidizing agent from a nozzle into a combustion furnace in order to burn the carbon in the fly ash and to fuse the fly ash, and then the fused fly ash is quenched in a cooling furnace. Because silica content in the combustion ash of the petroleum coke is extremely low, it is impossible to prepare fly ash from the combustion ash of petroleum coke.

These technologies mentioned above are the ones corresponding to the combustion ash from the industrial boilers that use crude petroleum and coal mainly as fuel, and thus, it is not applicable in the combustion ash from different industrial boilers that use the petroleum coke as fuel. Moreover, these technologies are the ones which utilize the carbonaceous constituent contained in the combustion ash as fuel, or which enhance the quality of fly ash by decreasing carbonaceous constitution. Thus, it is not a technology under directing an attention to the specific carbonaceous constituent of the combustion ash from the industrial boilers using the petroleum coke as fuel, and of utilizing the carbonaceous constituent as a value added product.
[Patent Literature 1] Japanese examined publication SHO 39-20061 (JP-SHO 39(1964)-20061 B)
[Patent Literature 2] Japanese examined publication SHO 63-59963 (JP-SHO 63(1988)-59963 B)
[Patent Literature 3] Japanese unexamined publication HEI 3-164416 (JP-HEI 3(1991)-164416 A)
[Patent Literature 4] Japanese unexamined publication HEI 7-213949 (JP-HEI 7(1995)-213949 A)
[Patent Literature 5] Japanese unexamined publication HEI 10-281438(JP-HEI 10(1998)-281438 A)

### DISCLOSURE OF THE INVENTION

Problems to be Solved by the Invention

Therefore, the present invention aims to provide amorphous carbon particles which excel in rigidity and material strength, possess a particularly small specific surface area and a particularly small porevolume economically. The present invention also aims to provide a composite material of which characteristics are improved by blending such amorphous carbon particles.

Means for Solving the Problems

The present invention which solves the above mentioned problems is amorphous carbon particles extracted from combustion ash of petroleum coke, each of which provides a non-circular section, and which have a weight depreciation rate after 60 minutes' standing at a maintaining temperature of 500° C. in the presence of air being in the range of less than 30%, and also have a mean average particle size of 50-1 μm.

The present invention also discloses the amorphous carbon particles of which specific surface area measured by BET method is in the range of 20-1 m²/g and of which pore volume measured by the nitrogen adsorption method is in the range of 0.020-0.001 ml/g.

Further, the present invention discloses the amorphous carbon particles of which spacing measured by X-ray diffraction is not less than 3.43 Å.

Further, the present invention which solves the above mentioned problems is a composite material in which amorphous carbon particles extracted from the combustion ash of the petroleum coke are blended into a matrix comprising an organic material or an inorganic material, wherein each of particles provides a non-circular section, and wherein the particles have a weight depreciation rate after 60 minutes' standing at a maintaining temperature of 500° C. in the presence of air being in the range of less than 30%, and also have a mean average particle size of 50-1 μm.

The present invention also discloses the composite material wherein the amorphous carbon particles are blended at a rate of 10-70% by weight of the composite material

Furthermore, the present invention which solves the above mentioned problems is a carbon-carbon composite material in which amorphous carbon particles extracted from the combustion ash of the petroleum coke are mixed with another carbon particles, wherein each of amorphous carbon particles provides a non-circular section, and wherein the amorphous carbon particles have a weight depreciation rate after 60 minutes' standing at a maintaining temperature of 500° C. in the presence of air being in the range of less than 30%, and also have a mean average particle size of 50-1 μm.

The present invention also discloses the carbon-carbon composite material wherein the amorphous carbon particles are blended at a rate of 10-70% by weight of the composite material.

In addition, the present invention which solves the above mentioned problems is a cement composition in which the above mentioned amorphous carbon particles are blended with an inorganic binder.

The present invention also discloses the cement composition wherein the amorphous carbon particles are blended at a rate of 10-70% by weight of the total solid in the cement composition.

Effects of the Invention

According to the present invention, since the amorphous carbon particles which excel in rigidity and material strength, possess a particularly small specific surface area and a particularly small pore volume can be prepared from the combustion ash of the petroleum coke, it is an economical way.

Moreover, when blending these amorphous carbon particles into an organic material such as resin or rubber, an inorganic material such as metal, glass or ceramics, a cement composition, or another carbon material, it is possible to provide a composite material of which characteristics such as electric resistance, electrification characteristic, heat resistance, and mechanical strength, etc., are improved. Therefore, it can be expected that the amorphous carbon particles are utilized for various molded articles' and structural articles' fields, semiconductors' fields, heat transfers' field and the like.

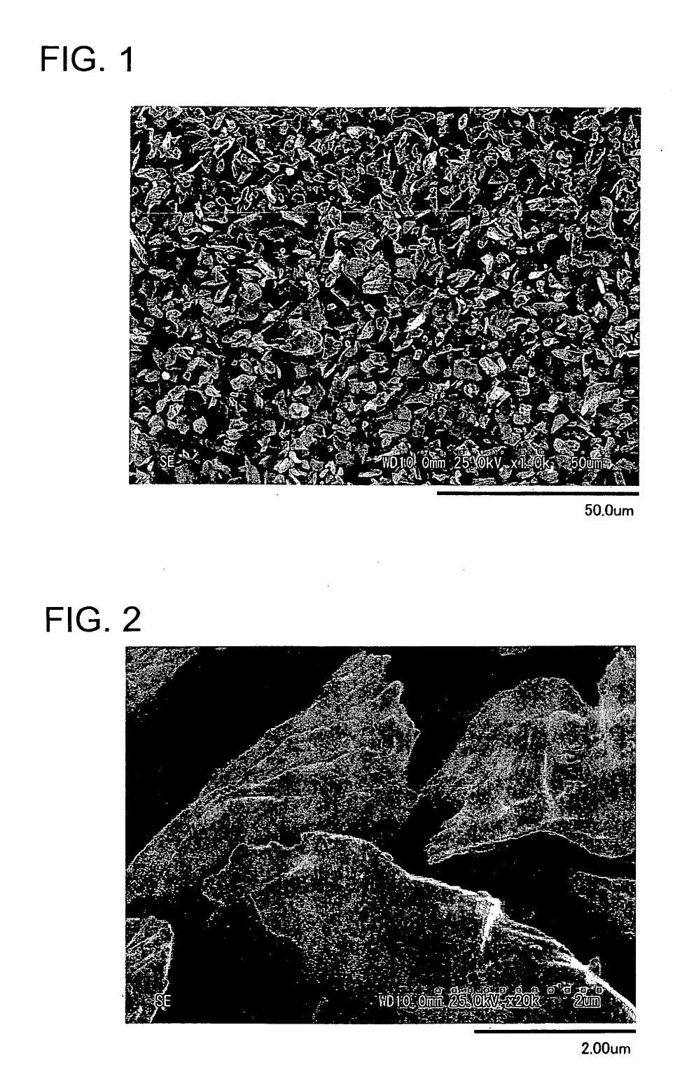

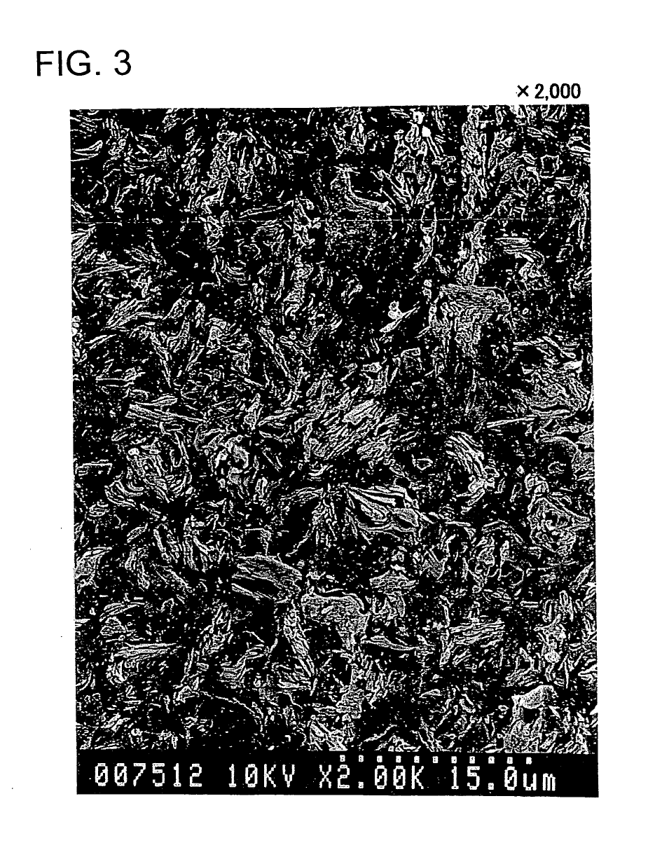

### BRIEF DESCRIPTION OF THE DRAWINGS

[FIG. 1] is an electron micrograph of 1000 times magnification which shows particle shapes of the amorphous carbon particles according to the present invention.

[FIG. 2] is an electron micrograph of 2000 times magnification which shows particle shapes of the amorphous carbon particles according to the present invention.

[FIG. 3] is an electron micrograph of 2000 times magnification which shows a state when the amorphous carbon particles according to the present invention is blended to a resin.

### BEST MODE FOR CARRYING OUT THE INVENTION

Now, the present the present invention will be described in detail with reference to some embodiments as follows.

The amorphous carbon particles according to the present invention are the ones extracted from the combustion ash of the petroleum coke. Heretofore, although it was known that a large volume of unburned carbon is contained in particles of the combustion ash from petroleum coke, only such utilization as the combustion ash is subjected to re-combustion in order to remove the unburned carbon was developed.

Under my studies for effective utilization of such a combustion ash, I have found that the carbon which is obtained by acid-rinsing ash content (metal oxides) out of the combustion ash, separating carbon content with a liquid-solid separation, then drying, pulverizing and granulating the obtained carbon content is non-crystal, namely, amorphous one, and which excels in rigidity, strength, and thermal resistance, and possesses a particularly small specific surface area and a particularly small pore volume, and the particles of which carbon content provide non-circular sections having acute angle edges, and show complicated shapes each having acute angle's protuberances and/or flat curve faces on the particle surface, but they do not show a flake or spherical shape, and thus they can perform excellent properties when they are used singly, or by blending into a matrix such as resin, rubber, etc. Based on this finding, I can arrive at the present invention.

Petroleum coke as the raw material of the amorphous carbon particles according to the present invention is a carbonaceous product, as conventionally known, which is obtained as a solid side product after separating volatile fractions such as gasoline, kerosene, gas oil, etc., wherein the separation of volatile fractions are performed in a process of crude oil refining by heating heavy residue (asphalt content) which is mainly discharged from a vacuum distillation system up to 500-600° C. in order to induce coking reaction, thermal cracking, and volatilization of the above mentioned fractions.

Properties of the petroleum coke are not limited particularly because they are varied depending on the coke's producing field of crude oil and on the manufacturing process. As the properties of the petroleum, however, it may be exemplified that all moisture thereof is 4-8%, the ash content 0.3-0.6%, the volatile component content 10-14%, the calorific value 8000-9000 kcal/kg, sulfur content 0.5-6%, and vanadium content 300-2500 ppm.

The amorphous carbon according to the present invention is the one extracted from the combustion ash produced from a combustion furnace using such a petroleum coke as fuel, such as pulverized fuel boiler, the gasification furnace, etc. As combustion conditions in such a combustion furnace, for example, it can be exemplified that it is 1-24 hours at 800-1300° C. under the oxidation atmosphere, although the conditions are not especially limited thereto.

As a composition of the combustion ash that becomes the raw material, for instance, the composition may comprise H₂O 0.1-1% by weight, C 72-90% by weight, H 0.1-1.5% by weight, O 1-10% by weight, Cl 0.01-0.1% by weight, NH₃ 1-3% by weight, SO₄ 3-20% by weight, V 0.50-2.50% by weight, Fe 0.10-1.00% by weight, Mg 0.02-0.10% by weight, P 0.01-0.10% by weight, Ca 0.05-0.25% by weight, Na 0.05-0.25% by weight, K 0.01-0.05% by weight, Al0.05-0.30% by weight, Si 0.02-0.80%, Ni 3500-6500 mg/Kg, and Mo 50-100 mg/Kg, although the composition is not particularly limited thereto. For a reference, a typical composition may be exemplified as H₂O 0.5% by weight, C 78.9% by weight, H 0.8% by weight, O 7.14% by weight, Cl 0.04% by weight, NH3 2.45% by weight, SO4 16.10% by weight, V 1.00% by weight, Fe 0.23% by weight, Mg 0.07% by weight, P 0.04% by weight, Ca 0.21% by weight, the Na 0.10% by weight, the K 0.03% by weight, the Al 0.24% by weight, Si 0.78%, Ni 4600 mg/Kg, and Mo 90 mg/Kg.

The method of manufacturing the amorphous carbon particles according to the present invention may be done by collecting the combustion ash which is trapped with a dust extractor equipped on the boiler using as fuel such a petroleum coke, adding acid water and, as needed, a reducing agent, heating and stirring the mixture of the combustion ash and the acid water in order to separate the carbon content insoluble in the acid from the metal oxides soluble in the ash by solid-liquid separation, rinsing the separated carbon content, and then drying and pulverizing the rinsed carbon content. Incidentally, in advance of the addition of acid water to the combustion ash, the combustion ash may be subjected to humidification treatment if necessary. The humidification treatment will bring the combustion ash to be in the state of easy handling, and also will improve elution of the metal content at the metal extraction.

As the acid water used in the method of manufacturing the amorphous carbon particles according to the present invention, sulfuric acid, hydrochloric acid, nitric acid, and mixtures thereof may be used. Among them, sulfuric acid and hydrochloric acid are preferable because their solvencies to the metals are superior to the others, and sulfuric acid is most preferable. If the addition of the acid water is omitted, the extraction rate of metal in the metallic extraction processing step becomes low, and thus it is undesirable.

As pH value of the acid water, for example, .pH 0.1-3.0, particularly, pH 0.5-1.0 is preferable, although it is not especially limited thereto. When pH is less than 0.1, a large amount of acid water may be used for the treating process. When pH exceeds 3.0, the extraction efficiency to vanadium will become low.

The amount of addition of the acid water, for example, may be in the range of 2 to 10 times as large as the amount (dry weight) of the combustion ash to be treated, although it is not especially limited thereto. When the adding amount of acid water is less than twice, the dissolution treatment to the solvable contents may progress insufficiently. On the other hand, when the adding amount of acid water is more than ten times, it is not economical, and it is likely to become hard and large the labor that hangs to the waste fluid processing after solid-liquid separation.

As the reducing agent which can be used in combination with the acid water as needed, for instance, sulfurous acid, hydrazine, and hydroxylamine may be used, although the reducing agent is not limited thereto. Among them, sulfurous acid and hydrazine are preferable because of their outstanding reduction action. Sulfurous acid is most preferable.

Such a reducing agent is added to the combustion ash at almost the same time with the addition of the acid water before heating. As the addition amount of the reducing agent, it is preferable to add 0.02-1.0 part by weight, more desirably, 0.1-0.6 part by weight of the reducing agent per 100 parts by weight (dry weight) of combustion ash, although it is not limited thereto. When the addition amount of the reducing agent is less than 0.02 part by weight, there is a fear that the reduction reaction may proceed insufficiently. When the addition amount of the reducing agent exceeds 1.0 part by weight, there is a fear that a necessity of adding a treatment step for the residual reducing agent will arise, and thus the operation of the process will increase in complexity.

After the addition of the acid water, and optionally the reducing agent, to the combustion ash, the resultant mixture is heated to a temperature of not less than 40° C., more preferably, a temperature in the range of 50-80° C., and is subjected to stirring at a predetermined rotational rate in order to dissolve adequately the metal contents which is included in the combustion ash and which is solvable to the acid. Because the extraction rate may become low when the temperature is less than 40° C., the heating temperature of not less than 40° C. is applied.

Although it is not especially limited, as the stirring method, for instance, general methods such as a method of using a stirrer of four-inclined impellers may be adaptable. The stirring condition can be varied appropriately depending on the density, the temperature, etc. , of the acid water in the extractant. For instance, assuming that sulfuric acid aqueous solution, pH 0.6, is added in amount of double weight of the combustion ash to be treated and the temperature of the solution is set to 60° C., about 90 minutes' stirring treatment may be appropriate.

By above mentioned metal extraction treatment using the acid water and the reducing agent, metal constituents included in the combustion ash, such as V, Al, Fe, Mg, Mo, Ni, etc., are dissolved in water, and, while the carbonaceous constituent remains as solid insoluble.

It is not especially limited as solid-liquid separation process, and, for instance, the separation may be performed by using a pressure filter, a centrifugal separator, a decanter, a belt filter, a tray filter, a precoat filter, a ceramic filter, cricket filter, press roll filter, etc.

The wet carbonaceous constituent obtained by the solid-liquid separation is optionally rinsed thoroughly with heated water of 20-80° C., for instance, and more desirably, heated water of about 60° C. As far as the adhering acid water can be adequately removed, the rinsing method is not especially limited, and various systems can be used for the rinsing.

As the drying process, for instance, air drying in the temperature of 100-200° C., oven drying, and natural drying, or the like may be adaptable, although it is not especially limited thereto. Further, on the basis of the fact that the amorphous carbon particles according to the present invention have electro conductivity, a drying method of applying electricity may be also contemplated. In any case, because the amorphous carbon particles according to the present invention is extremely small in their specific surface area and their pore volume, and is excellent in the thermal transmission, it is possible to dry the amorphous carbon with a high efficiency.

The pulverizing process may be performed by using a physical pulverizer such as turbo mill, ball mill, jet mill, the roller mill, for example, although it is not especially limited thereto. Since the carbonaceous constituent to be pulverized possesses a high hardness and it is already in shape of minute particles, it is desirable to use the jet mill as pulverizer. After the he pulverizing process, classification process may be adaptable optionally.

The thus obtained amorphous carbon particles according to the present invention provide non-circular sections having acute angle edges, and show complicated shapes each having acute angle's protuberances and/or flat curve faces on the particle surface as shown in FIG. 1, but they do not show flake shape like graphite or spherical shape like carbon black. The mean particle size thereof is in the range of 1-50 μm, and more desirably, in the range of 1-10 μm. Incidentally, such shapes of providing non-circular sections having acute angle edges can bring an expectation for anchoring effect when the amorphous carbon particles are combined with a matrix material such as resin, rubber, cements, metal, etc., and an expectation for spike effect on the surface of the compound material.

Further, the amorphous carbon particles show a weight depreciation rate of less than 30%, more desirably, of less than 20%, after they are left to stand at maintaining temperature of 500° C. for 60 minutes in the presence of air. Thus, they are the carbons of very low reactivity and with a high stability.

Moreover, it is clear that the amorphous carbon particles according to the present invention takes an amorphous structure since the spacing measured by X-ray diffraction is not less than 3.43 Å, for instance

Moreover, since the amorphous carbon particles according to the present invention has a specific surface area measured by BET method of about 20-1 m²/g and has a pore volume measured by the nitrogen adsorption method of about 0.020-0.001 ml/g, they have relatively dense surface profiles.

In addition, as other typical characteristics of the amorphous carbon particles according to the present invention, it is possible to mention that the specific gravity measured by the manual filling method is 0.5-0.7 g/ml and the true specific gravity measured in accordance with JIS K21515.3 is 1.9-2.1, although it is not especially limited thereto

The amorphous carbon particles according to the present invention as they are can be used as, for instance, various catalyst supports and flow layer medium.

Moreover, the amorphous carbon particles according to the present invention can be mixed with a matrix material which involves organic materials such as various resins and rubbers and inorganic materials such as cements and metals, for the purpose of giving electro conductivity, improving rigidity and mechanical strength, improving size stability, improving thermal resistance, etc., because the amorphous carbon particles according to the present invention can show affinities to both oleaginous substrate and aqueous substrate. Concretely, for instance, it can be preferably used as coloring agent for resin or rubber molding material, or shading fibers, etc.; as modifier or filler for resin or rubber; electro resistance regulating agent for antistatic material, resistant material in a copying machine, sheet heater utilizing PTC (positive temperature coefficient) characteristic; artificial marble; or the like.

Moreover, it is also considered that the amorphous carbon particles can be applied to various liquid compositions such as lubricants, traction driving fluids, electric viscous fluids; nonlinear optical materials; or coloring composition such as various inks and paints.

In addition, it is possible to be mixed with the matrix material which comprises inorganic substances such as the cement composition, metal, and glass, preferably, in various usages such as colorant, filling materials, aggregates, etc.

Additionally, the carbon-carbon composite material that has a new characteristic can be made by combining the carbon particles according to the present invention with other carbon materials with a different characteristic.

Composite material according to the present invention is composed of the aforementioned amorphous carbon particles according to the present invention and a matrix to which the amorphous carbon particles are blended and which involves organic materials such as various resins and rubbers and inorganic materials such as cements and metals, and glasses.

Although the additive amount of the amorphous carbon particles would be varied by the purpose of the addition, the kind of the organic material such as resin or rubber or the inorganic material such as cement composition, metal or glass as the matrix, the amorphous carbon particles can be added in an amount of 10-70% by weight based on the weight of the composite material. Even when the additive amount of the amorphous carbon particles is as much as 70% by weight, the amorphous carbon particles can be blended into the matrix with a uniformly distributed state. It can be considered that the uniformly distributed state is attained because the amorphous carbon particles according to the present invention can show affinities to both oleaginous substrate and aqueous substrate, and the amorphous carbon particles has aforementioned particle shapes of providing non-circular sections, and thus anchoring effect to the matrix is as high as the highly distributed state can be maintained. Incidentally, the composite material according to the present invention involves not only ones which include a predetermined amount as final product of the amorphous carbon particles, but also ones which are in the so-called “master batch” state and are used for preparing final products of relatively low content with a improved dispersibility.

The composite material according to the present invention can be prepared by blending the above mentioned amorphous carbon particles to a resin or rubber composition which is in liquidity position, and then mixing or kneading them in accordance with the conventional procedure in the art. In the case of the cement composition, the above mentioned amorphous carbon particles can be blended to the cement composition which is in the state of powder, or the state of paste which is prepared by adding water to the powder. Similarly, in the case of metal, glass or the like, the above mentioned amorphous carbon particles can be blended to the matrix material which is in the state of powder or in liquidity position.

Incidentally, as occasion demands, it is also possible to apply to the amorphous carbon particles a conventional surface treatment, such as plasma treatment, electron irradiation, polymer grafting treatment, polymer coating treatment, etc., in advance of blending the amorphous carbon particles to the matrix such as resin, rubber, or the like.

The resin or rubber which forms the matrix to which the amorphous carbon particles according to the present invention is blended is not the one especially limited.

As thermoplastic resins, for instance, olefin type resins and copolymers thereof such as polyethylene, chlorinated polyethylene, ethylene-vinyl acetate copolymer, ethylene-ethyl acrylate copolymer, polypropylene, ethylene-propylene copolymer, polybutylene, poly-4-methylpentene-1, etc.;

vinyl chloride type resins and copolymers thereof, and vinylidene chloride type resins and copolymers thereof, such as polyvinyl chloride, vinyl chloride-vinylidene chloride copolymer, vinyl chloride-vinyl acetate copolymer, vinyl chloride-(meth) acrylic acid ester copolymer, vinyl chloride-acrylonitrile copolymer, ethylene-vinyl chloride copolymer, propylene-vinyl chloride copolymer, polyvinyl chloride grafted ethylene-vinyl acetate copolymer, etc.;

styrene type resins and copolymers thereof such as polystyrene, styrene-(meth)acrylic acid ester copolymer, acrylonitrile-butadiene-styrene copolymer (ABS resin), acrylonitrile-styrene copolymer (AS resin), acrylonitrile-chlorinated polyethylene-styrene copolymer (ACS resin), etc.;

(meth)acryl acid type resins and copolymers thereof such as polymethyl methacrylate, or other mono- or co-polymers of acrylic acid or methacrylic acid type monomers such as acrylic acid, methyl acrylate, ethyl acrylate, propyl acrylate, n-butyl acrylate, isobutyl acrylate, dodecyl acrylate, stearyl acrylate, 2-ethylhexyl acrylate, methacrylic acid, methyl methacrylate, ethyl methacrylate, propyl methacrylate , n-butyl methacrylate, isobutyl methacrylate, n-octyl methacrylate, dodecyl methacrylate, 2-ethylhexyl methacrylate, etc.;

polyamide type resins such as nylon 6, nylon 66, nylon 610, nylon 11, nylon 8, poly-p-phenylenene terephthal amide, etc., and polyimide type resins and poly amide-imide type resins;

fluorine containing type resins such as polytetrafluoroethylene, polyvinylidene fluoride, polyethylene-propylene fluoride, tetrafluoroethylene-perfluoroalkoxy ethylene copolymer, ethylene-petrafluoroethylene copolymer, polychloro trifluoro ethylene, etc.;

cellulose type resins such as cellulose acetate, cellulose acetate butyrate, cellulose ester, cellulose ethylate, etc.;

thermoplastic polyester type resins such as polyethylene terephthalate, polybutylene terephthalate, etc.; and

other resins such as polycarbonate, polyacetal, polyphenylene oxide, polyphenylene sulfide, polysulfone, polyamino bismaleimide, polyethersulfone, polyphenylene sulfone, polyarylsulfone, polyarylate, grafted polyphenylene ether, polyetherketone, polyether ether ketone, polyether imide, ionomer, various silicone resins, etc., are included.

As the thermosetting resin, for instance, phenolic resins, urea resins, melamine resins, xylene resins, furan resins, diallyl phthalate resins, unsaturated polyester resins, alkyd resins, epoxy resins, polyurethane resins, alkyl benzene resins, benzoguanamine resins, and other various modified resins thereof are included, although it is not especially limited thereto.

Moreover, as the rubber, for instance, natural rubbers and derivatives thereof such as natural rubber, chlorinated rubber, hydrochlorinated rubber, cyclized rubber, etc.; butadiene type synthetic rubbers such as styrene-butadiene rubber (SBR), nitrile rubber (butadiene-acrylonitrile copolymer, NBR), chloroprene rubber, etc.; olefin type synthetic rubbers such as polyisoprene, butyl rubber, etc. ; epichlorohydrin rubbers; polysulfide type synthetic rubbers such as brominated butyl rubber Thiokol A, Thiokol B, etc.; acrylic rubbers; chlorosulfonated polyethylene; and thermoplastic elastomers which can also be classified as the above thermoplastic resins, such as vinyl chloride resin elastomer, ethylene-propylene elastomer, ethylene-vinyl acetate elastomer, chlorinated polyethylene elastomer, styrene-butadiene elastomer, thermoplastic polyurethane elastomer, etc.; and others such as silicone rubbers, fluorinated rubbers, urethane rubbers, etc., are enumerated.

In the composite material according to the present invention, conventional various additives or compounding ingredients can be added optionally to in the matrix which comprises the above mentioned resin or rubber in addition to the aforementioned amorphous carbon particles

As such various additives or compounding ingredients, thermal stabilizing agents, antioxidants, ultraviolet rays absorbents, plasticizers, coloring agents, flame retardants, foaming agents, fillers other than the aforementioned amorphous carbon, mold lubricants, surface treating agents, lubricants, anti-blocking agents, etc., are included for instance, although it is not limited thereto. As the thermal stabilizing agents, for instance, various fatty acid metallic salts or esters such as lead stearate, dibutyl tin laurate, tribenzyl tin laurate, cadmium stearate, zinc stearate, barium stearate, strontium stearate, magnesium stearate, calcium stearate, cadmium laurate, zinc laurate, barium laurate, strontium laurate, magnesium laurate, calcium laurate, etc., are enumerated although these are just a few examples. As the antioxidants, for example, alkyl phenols, amines, quinones, etc., are enumerated although these are just a few examples. As the ultraviolet rays' absorbents, for instance, salicylic acid esters, benzoic acid esters, etc., are enumerated although these are just a few examples. As the plasticizers, for instance, phthalic acid esters, sebacacic acid esters, adipic acid esters, phosphoric acid esters, aliphatic dibasic acid ester, polyester compounds, epoxy compounds, chlorine included compounds, recinoleic acid esters, diethylene glycols, butadiene acrylonitriles, and sulfonamides, etc., are enumerated, although the plasticizers vary depending on the kind of the added resin, and these are just a few examples. As the coloring agents, various pigments (including extender pigments) and dyestuffs are included. As the flame retardants, for instance, chlorinated paraffin, tricresyl phosphate, chlorinated oil, tetrachloro phthalic anhydride, tetrabromo phthalic anhydride, tetrabromo bisphenol A, antimony oxide, aluminum hydroxide, and barium borate, etc., are enumerated although these are just a few examples. As the foaming agents, for instance, low boiling point solvents such as propane, butane, etc., for physical foaming; and azonitrile compounds, benzene sulfohydrazine compounds, diazoamide compounds, etc., for chemical foaming, are enumerated although these are just a few examples. As the fillers other than the aforementioned amorphous carbon, for instance, glass fibers, glass beads, calcium carbonate, calcium silicate, titanium white, lignin, asbestos, mica, silica, aluminum oxide, magnesium oxide, boron nitride, silicon oxide, natural or synthetic fibers, carbon black, white carbon, etc., are enumerated although these are just a few examples. As the mold lubricants and the surface treating agents, for instance, natural and synthetic waxes such as carnauba wax, paraffin-wax, etc.; polyethylene waxes; silicone oil; etc., are enumerated although these are just a few examples. As the lubricants, for instance, stearic acid metallic salts and isobutyl stearate, etc., are enumerated although these are just a few examples. As the anti-blocking agents, for instance, inorganic minute particles such as talc powder, rosin powder, colloidal silica, hydrophobic silica, hydrophobic titania, hydrophobic zirconia, etc.; and, in addition, organic minute particles such as polystyrene beads, (meth)acrylic resin beads, etc., are enumerated although these are just a few examples. Further, as the antistatic agents, for example, various surfactants such as aliphatic sulfonic acid salts and higher alcohol sulfates, etc. are enumerated, although these are just a few examples.

Moreover, on the purpose to improve the dispersibility of the amorphous carbon powder in the matrix, it is also possible to add a material that has an affinity for the matrix which comprises aforementioned resin or rubber and has an affinity for the amorphous carbon powder, for instance, a block or graft polymer which has a graft or block chain having an affinity for the matrix and another graft or block chain having an affinity for the amorphous carbon powder, various surfactants or amphipathic compounds, etc. As the above mentioned block or graft polymer, those which have a low molecular weight of not more than 3000, i. e., so-called “oligomers” are also involved.

Further, in the case that the matrix comprises a thermoplastic resin, it is also possible to add a cross linking agent as needed. As such a crosslinking agent, for instance, aromatic divinyl compounds such as divinyl benzene, divinyl naphthalene, and their derivatives, etc.; diethylenic unsaturated carboxylic acid esters such as ethylene glycol dimethacrylate, diethylene glycol dimethacrylate, triethylene glycol dimethacrylate, trimethyl propane triacrylate, allyl methacrylate, t-butyl aminoethyl methacrylate, tetraethylene grycol dimethacrylate, 1,3-butandiol dimethacrylate, etc.; all divinyl compounds of N, N-divinyl aniline, divinyl ether, and divinyl sulfonic acid, and compounds having three or more vinyl groups; are enumerated. In addition, polybutadiene, polyisoprene, unsaturated polyesters, and chlorosulfonated polyolefins are also effective. With respect to the cross linking agent or curing agent to be used when the matrix is made of a thermosetting resin or rubber, because all of them well known and conventionally used in the art can be used herein, the explanation is omitted.

As the procedure for manufacturing the composite material according to the present invention which blends the amorphous carbon particles into the matrix which comprises such a resin or rubber, there is no particular limitation. In accordance with the kind of the resin or rubber, for example, the procedure can be proceeded by melting and kneading, blending and dispersing the amorphous carbon particles to the unlinked prepolymer composition, and pre-vulcanization kneading, etc. Further, such a procedure can be performed by using the conventional apparatuses used for kneading such as ball mills, mixers, kneader, etc., and conventional stirring vessels used for stirring. Alternatively, when the composite material is subjected to primary molding for products such as extrusion molding, or injection molding, etc, the procedure can be done in an apparatus for such a molding at almost same time with the molding.

As previously described, even when the mixing rate of the amorphous carbon particle is, for instance, as high as 70% by weight, the thus obtained composite material enjoys excellent characteristics such as electric resistance, electrostatic charge property, thermal resistance, mechanical strength, etc., because the carbon amorphous particles according to the present invention have a good dispersibility to various resins' and rubbers' matrixes. Meanwhile, since the amorphous carbon particles according to the present invention enjoys various excellent physical properties as mentioned above, it is fully expected that the improvements in the characteristics such as electric resistance, electrostatic charge property, thermal resistance, mechanical strength, etc., of the obtained composite material can attain an effective level even when the additive amount of amorphous carbon particles is not in a considerably high level.

As the inorganic material which forms the matrix, for example, various metals or metallic alloys, various glasses, various hydraulic compositions typified by cements, various air-setting compositions, and various ceramics can be used.

In addition, as the other carbon material which is used when the carbon-carbon complex is formed, various ones such as natural or artificial graphites, carbon blacks, amorphous carbons other than the amorphous carbon particles according to the present invention, fullerenes, nanotubes, nanocorns, nanofibers, etc., are involved, although it is not limited thereto. Further, as the shape of the other carbon material, various shapes such as carbonaceous materials of powder, fiber, milled fiber, mat, felt, paper-like and film, and spherical carbonaceous materials such as meso-carbon micro beads are involved. In addition, pulverized powder of low temperature calcined cokes, pulverized powder of rare cokes, graphitized breeze cokes, aggregates of milled carbon fibers, graphitized carbon fiber, condensed polycyclic hydrocarbon compounds such as naphthalene and phenanthrene, and condensed heterocyclic compounds such as petroleum pitch and coal pitch, are also involved. As the aggregates of milled carbon fibers, it is also possible to utilize ones of being in a low graphitized level, and ones of being in so-called “carbonized level”, in addition to the graphitizedones, i.e., aggregates of milled graphitized carbon fibers.

Further more, depending on the manufacturing circumstances, precursors for carbon fibers, or carbon sources are also utilizable. The precursors for carbon fibers can be prepared from any fibers as far as the fibers can be turned into carbon or graphite by heating. The fibers involve PAN (polyacrylonitrile) fibers, previously oxidized acrylonitrile resin fibers, pitch fibers, CVD carbon fibers, a pyrolytic natural fibers such as pyrolytic cotton fiber, and mixtures thereof. Moreover, in general, as the carbon sources for matrix material, any sources can be used as far as the sources can be turned into graphite by heating, and for instance, CVI (chemical vapor phase infiltration method) carbon sources; carbon sources capable of decomposing pyrolytically such as phenolic resins, pitches, and hydrocarbons such as methane, ethane, and propanes; and mixtures thereof are involved.

Although the manufacturing method for the carbon-carbon complex according to the present invention is not especially limited, for instance, a method wherein the amorphous carbon particles according to the present invention and other carbon materials are mixed with or made into contact with each other, and then the resultant is subjected to compression molding; a method wherein the amorphous carbon particles according to the present invention is molded in combination with self-sintering carbon source or carbon precursor, and then the resultant is subjected to heating in order to carbonize it; a method using a binder, and other conventional various methods, are utilizable.

With respect to the carbon-carbon complex of the present invention, the mixing rate of the amorphous carbon particles of the present invention is not particularly limited. It is preferable, however, to be in the range of 10-70% by weight based on the weight of the complex, in view of the fact that the characteristics of obtained carbon-carbon complex, such as thermal stability; thermal shock resistance and low thermal expansion depending on high thermal conductivity; and toughness, strength and rigidity under high temperature usage; are properly enhanced.

As the usage of the carbon-carbon complex according to the present invention, for instance, various electrode materials; nipples; linings of disk brake pads such as for vehicles and aircrafts, rotors of wheel support bearing unit and friction parts such as friction plates for wet multiple disc clutch; filter supports; targets of X-ray tube device; and other various structural articles and special carbon products, etc., can be enumerated, but it is not limited thereto.

The cement composition according to the present invention is characterized by comprising at least an inorganic binder and the above mentioned amorphous carbon particles of the present invention.

As the inorganic binder, various cements, and optionally, other minute particles, and expansive admixtures, etc., are involved, although it is not limited thereto. As the cements, various Portland cements such as normal, high-early-strength, moderate heat, and low heat Portland cements; various mixed cements such as Portland blast furnace cement-Portland fly ash cement, etc.; cements (eco-cements) which utilize as raw materials wastes such as municipal waste-burned ash, sewage sludge-burned ash, etc., are enumerated. As the other minute particles, fumed silica, silica dust, silica powder, and lime stone powder, etc., are enumerated. As the expansive admixtures, calcium sulfoaluminate type expanding agents, and lime type expanding agents, etc., are enumerated.

Moreover, in the cement composition, it is possible to add, optionally, fine aggregates such as river sand, land sand, sea sand, crushed sand or blends thereof, etc., and coarse aggregates such as river gravel, pit gravel, sea gravel, macadam or blends thereof, etc. In addition, it is also possible to add, optionally, water reducing agents such as lignin type, naphthalene sulfonic acid type, melamine type, and polycarboxylic acid type water reducing agents, and AE water reducing agent, etc.

With respect to the cement composition of the present invention, the blending rate of the amorphous carbon particles of the present invention is not particularly limited. It is preferable, however, to be in the range of 10-70% by weight based on the weight of the total solids, in view of the fact that the characteristics such as strength after cement curing are properly enhanced.

In the present invention, the procedure of preparing the cement composition (kneading procedure) is not especially limited. The preparation may be proceeded by blending cement, minute particles, and expansive admixture in advance, and then adding the resultant blend, the amorphous carbon, fine aggregate, coarse aggregate, water reducing agent, and water into a mixer, and kneading them by the mixer Alternatively, the preparation may be proceeded by adding almost simultaneously all of cement, minute particles, and expansive admixture, the amorphous carbon, fine aggregate, coarse aggregate, water reducing agent, and water into a mixer, and kneading them by the mixer. As the mixer, conventional mixers may be used. Moreover, as the curing method, there is no particular limitation. Any one of aerial curing, underwater curing and steam curing, etc., is adaptable.

### EXAMPLES

Now, the present invention will be more concretely described on the basis of the following examples.

### Example 1

Preparation of Amorphous Carbon Particles

After petroleum coke had been burnt using the pulverized fuel boiler (combustion condition: combustion at 800-1300° C. under oxidation atmosphere), combustion ash which had been trapped with a dust extractor was collected.

When the composition of this combustion ash was analyzed, components' result was obtained as moisture 0.4% by weight, carbon content 86.3% by weight, hydrogen 0.21% by weight, oxygen 1.23% by weight, NH₃ 1.63% by weight, SO₄ 4.10% by weight, V 1.25% by weight, Ni 0.58% by weight, Fe 0.56% by weight, Mg 0.06% by weight, Ca 0.25% by weight, Na 0.16% by weight, Al 0.24% by weight, and Si 0.69%

To the obtained combustion ash, humidification treatment was applied. After the humidification treatment, acid water (5% sulfuric acid aqueous solution) 200 parts by weight was added to the combustion ash 100 parts by weight in a stirring vessel, and then, a reducing agent (sulfurous acid aqueous solution) 0.6 part by weight was added The pH of the mixture was kept at 0.6, and the mixture was stirred for one hour while the mixture was heated to 60° C. After that, the carbonaceous constituent insolvable to the acid was separated from metal oxide constituent solvable to the acid by solid-liquid separation using a belt filter, and rinsed with water. Then, the carbonaceous constituent was dried by an oven at 150° C. Finally, the dried carbonaceous constituent was pulverized using a jet mill, and classified in order to obtain carbon particles.

As a result of investigation of particle size for the obtained carbon particles using the laser diffraction method, it was found that the mean particle size of the particles was 4.2 μm and the standard deviation were 0.183, and both particles of less than 0.75 μm and of more than 20.0 μm were not detected.

Moreover, when various physical properties were examined about the obtained carbon particles, it was found that the specific surface area measured by BET method was 10.8 m²/g, the pore volume measured by the nitrogen adsorption method was 0.013 ml/g, the specific gravity measured by the manual filling method was 0.559 g/ml, and the true specific gravity measured in accordance with JIS K21515.3 was 2.05

Next, as a result of investigation of crystal structure for the obtained carbon particles using the X-ray diffraction method, it was found that the spacing d (i.e., the distance between two adjacent lattice planes) was 3.4587 Å, and the crystalline size was 3.12 Å, and thus it was indicated that the carbon particles exhibited amorphous structure (turbostratic structure).

Furthermore, in order to determine the reactivity of the carbon particles with air, the weight depreciation rate after left standing at maintaining temperature of 500° C. for 60 minutes in the presence of air was measured using a differential thermal analyzer (TGD3000, manufactured by SINKUU-RIKO, Inc.) (measurement condition: sample amount 20 mg, air flow rate 20 ml/min., temperature rising rate 20° C./min.) As a result, it was found that the weight depreciation rate was 13.9%, and thus the reactivity of the carbon particles was very low. Further, when amounts of impurities contained in the carbon particles were determined using a plasma ion source analyzer (ICP analyzer), it was found that the amount of vanadium (V) was 0.19% by weight, and the amount of nickel (Ni) was 0.04% by weight, and thus, the carbon particles with little impurities was obtained by an enhanced extraction effect. The electron micrographs of the obtained carbon particles are shown in FIGS. 1 and 2.

Control 1

For a comparison, with respect to a coal coke, the weight depreciation rate after left standing at 500° C. for 60 minutes was measured in the same procedure as Example 1. As a result, it was found that the rate of the coal coke was 60%, and which was an obviously different characteristic.

### Examples 2-4

Preparation of Polypropylene Composite Materials

Amorphous carbon particles obtained in Example 1 were blended into polypropylene (SunAllomer PM9100A, manufactured by SunAllomer, Ltd.) in respective amounts shown in Table 1 in a biaxial extruder (manufactured by Berstorff GmbH, screw's diameter =43 mm, L/D=37), and they are fused and kneaded therein under the conditions of rotation rate 100 rpm, feeding rate 10 kg/min., pelletizer rate 15 m/min., and resin temperature 225-226° C. in order to prepare a composite material. The obtained composite material was molded as dumbbell specimens (ASTM D628 type I) and disk specimens (diameter 50 mm×thickness 3 mm, and diameter 100 mm×thickness 1.6 mm) by an injection molding apparatus (Klöbeckner F40)

With respect to the obtained composite materials, specific gravity (JIS K7112), tensile strength (ASTM D638), tensile elongation (ASTM D638), tensile elastic modulus (ASTM D638), bending strength (JIS K7171), bending elastic modulus (JIS K7171), compressive strength (JIS K7181), Izod impact value (JIS K7110 (notched)), Rockwell hardness (JIS K7202), thermal deformation temperature (JIS K7207), thermal conductivity (ASTME1530), and volume resistivity (ASTM D257) were determined, and compared with the physical properties data of polypropylene to which the carbon particles were not added.

Table 1 shows the obtained results. In Table 1, PP and AC denote polypropylene, amorphous carbon, respectively.

TABLE 1

| | Control | Example 2 | | Example 3 | | Example 3 | |
|---|---|---|---|---|---|---|---|
| | (PP 100% by | (PP 70 wt % + | | (PP45 wt % + | | (PP35 wt % + | |
| | weight) | AC 30 wt %) | | AC 55 wt %) | | AC 65 wt %) | |
| | Measured | Measured | Change | Measured | Change | Measured | Change |
| Item | value | value | rate | value | rate | value | rate |
| Specific gravity | 0.911 | 1.038 | +14% | 1.282 | +41% | 1.386 | +52% |
| Tensile strength | 35.8 | 29.2 | −18% | 32.0 | −11% | 32.2 | −10% |
| (MPa) | | | | | | | |
| Tensile elongation | 7.88 | 3.35 | −57% | 1.84 | −77% | 1.50 | −81% |
| (%) | | | | | | | |
| Tensile modulus | 1.63 | 2.69 | +65% | 5.84 | +258% | 7.38 | +353% |
| (GPa) | | | | | | | |
| Bending strength | 48.8 | 51.7 | +6% | 59.2 | +21% | 59.9 | +23% |
| (MPa) | | | | | | | |
| Bending modulus | 1.70 | 2.45 | +44% | 6.03 | +255% | 7.94 | +367% |
| (GPa) | | | | | | | |
| Compressive | 57.2 | 60.8 | +6% | 81.3 | +42% | 89.1 | +56% |
| strength (MPa) | | | | | | | |
| Izot impact value | 1.6 | 1.8 | +13% | 1.3 | −19% | 1.2 | −25% |
| (KJ/m³) | | | | | | | |
| Rockwell strength | 58.7 | 52.5 | −11.0% | 70.6 | +20% | 76.2 | +30% |
| (M scale) | | | | | | | |
| Thermal | 59 | 80 | +36% | 117 | +98% | 129 | +119% |
| deformation | | | | | | | |
| temperature (° C.) | | | | | | | |
| Thermal | 0.19 | — | — | 0.54 | +184% | 0.72 | +279% |
| conductivity (W/mk) | | | | | | | |
| Volume resistivity | 2.5 × 10¹⁶ | — | — | 4.0 × 10³ | | 5.5 × 10³ | |
| (Ωcm) | | | | | | | |

### Example 5

Preparation of Polyamide Composite Material

30% by weight of the amorphous carbon particles obtained in Example 1 were blended into 70% by weight of nylon 6 type polyamide (NOVAMID 1013C5, manufactured by Mitsubishi Engineering-Plastics Corporation), and then the blend was fused and kneaded with a kneader (TEX-30 biaxial kneader, manufactured by Japan Steel Works, LTD.) under the conditions of rotation rate 300 rpm, and resin temperature 270-280° C. in order to prepare a composite material. The obtained composite material was molded as dumbbell specimens (JIS No. 1 dumbbell) and flat plate specimens (length 80 mm×width 120 mm×thickness 2 mm) by injecting it into dies (JIS dies) with a molding apparatus (120T injection molding machine, manufactured by Japan Steel Works, LTD.).

With respect to the obtained composite materials, density (JIS K7112), tensile fracture strength (JIS K7113), tensile fracture elongation (JIS K7113), bending strength (JIS K7203), bending elastic modulus (JIS K7203), Izod impact value (JIS K7110), thermal deformation temperature (JIS K7207), thermal conductivity (at 23° C., laser pulse heating method), and volume resistivity (Four probes method for less than 10⁸ Ωcm, and 50 mm diameter's electrode method for 10⁸ Ωcm) were determined.

Table 2 shows the obtained results. In Table 2, PA and AC denote polyamide, amorphous carbon, respectively. Further, FIG. 3 is an electron micrograph of 2000 times magnification which shows a sectional condition of the composite material thus obtained. As shown in FIG. 3, it is understood that the amorphous carbon particles which show non-circular sections are uniformly distributed in the resin matrix.

### Example 6

Preparation of Polyamide Composite Material

The same procedure as Example 5 was repeated except that the blending rate of the amorphous carbon particles obtained in Example 1 to the polyamide was changed to 45% by weight, in order to prepare another composite material. Then, the composite material was molded as dumbbell specimens (JIS No. 1 dumbbell) and flat plate specimens (length 80 mm×width 120 mm×thickness 2 mm).

With respect to the obtained composite material, various physical properties were determined as in the case of Example 5. The obtained results were shown in FIG. 2.

TABLE 2

| | | | | Execution | |
|---|---|---|---|---|---|
| | | | | example 5 | |
| | Control | Example 5 | | (PA70% by | |
| | (PA100 | (PA 70 wt % + | | weight + AC30% | |
| | wt %) | AC 30 wt %) | | by weight) | |
| | Measured | Measured | Change | Measured | Change |
| Item | value | value | rate | value | rate |
| Specific gravity | 1.14 | 1.29 | +13% | 1.40 | +23% |
| Tensile fracture | — | 81.9 | — | 92 | — |
| strength (MPa) | | | | | |
| Tensile fracture | 18 | 4.6 | −74% | 2.6 | −86% |
| elongation (%) | | | | | |
| Bending strength | 119 | 133 | +12% | 150 | +26% |
| (MPa) | | | | | |
| Bending modulus | 3000 | 4960 | +65% | 6940 | +131% |
| (GPa) | | | | | |
| Izot impact value | 4 | 4.7 | +18% | 3.2 | −20% |
| (KJ/m²) | | | | | |
| Thermal | 58 | 94 | +52% | 159 | +174% |
| deformation | | | | | |
| temperature (° C.) | | | | | |
| Thermal | — | 0.51 | — | 0.69 | — |
| conductivity | | | | | |
| (W/mk) | | | | | |
| Volume | 2.0 × 10¹⁴ | 3.0 × 10⁹ | | 1.5 × 10³ | — |
| resistivity (Ωcm) | | | | | |

1-9. (canceled)

10. Amorphous carbon particles which are extracted from combustion ash of petroleum coke, wherein each of the particles provide a non-circular section, and wherein a weight depreciation rate of the particles after 60 minutes' standing at a maintaining temperature of 500° C. in the presence of air is in the range of less than 30%, and wherein a mean average particle size of the particles is in the range of 50-1 μm.

11. Amorphous carbon particles according to claim 10, wherein specific surface area of the particles measured by BET method is in the range of 20-1 m²/g, and wherein pore volume in the particles measured by the nitrogen adsorption method is in the range of 0.020-0.001 ml/g.

12. Amorphous carbon particles according to claim 10, wherein spacing in the particles measured by X-ray diffraction is not less than 3.43 Å.

13. Composite material which comprises amorphous carbon particles according to claim 10 which are blended in a matrix which comprises an organic material or an inorganic material.

14. Composite material according to claim 13, wherein the amorphous carbon particles are blended at a rate of 10-70% by weight of the composite material.

15. Carbon-carbon composite material which comprises the amorphous carbon particles according to claim 10 which are mixed with another carbon material.

16. Carbon-carbon composite material according to claim 15, wherein the amorphous carbon particles are blended at a rate of 10-70% by weight of the composite material.

17. Cement composition which comprises at least an inorganic binder and the amorphous carbon particles according to claim 10.

18. Cement composition according to claim 17, wherein the amorphous carbon particles are blended at a rate of 10-70% by weight of the total solid in the cement composition.
